(19) United States
(12) Patent Application Publication
(10) Pub. No.: US 2024/0227588 A9
(43) Pub. Date: Jul. 11, 2024

(54) CHARGING CONNECTOR APPARATUS AND CHARGING CONNECTOR KIT

(71) Applicant: Dr. Ing. h.c. F. Porsche Aktiengesellschaft, Stuttgart (DE)

(72) Inventor: Bogdan Pentia, Ostfildern (DE)

(73) Assignee: Dr. Ing. h.c. F. Porsche Aktiengesellschaft, Stuttgart (DE)

(21) Appl. No.: 18/243,370

(22) Filed: Sep. 7, 2023

(30) Foreign Application Priority Data
Oct. 19, 2022 (DE) 10 2022 127 409.8

(51) Int. Cl. B60L 53/16; B60L 53/35

(52) U.S. Cl. CPC B60L 53/16; B60L 53/35

(57) ABSTRACT

A charging connector apparatus for an electrically driven motor vehicle. The apparatus has a charging socket designed in a country-specific manner and an adapter element for fastening the charging socket designed in a country-specific manner on a vehicle body which includes a charging port. In order to simplify the manufacture and assembly of the charging connector apparatus, the adapter element for fastening charging socket designed in a country-specific manner is attached to a combined drive-and-guide device for a cover which, with the aid of the combined drive-and-guide device, can be moved between a closed position in which the charging port is closed by the cover and an open position in which, with the aid of the combined drive-and-guide device, the charging port is exposed by the cover.

### CROSS-REFERENCE TO RELATED APPLICATION

This application claims priority to German Patent Application No. 10 2022 127 409.8, filed Oct. 19, 2022, the content of such application being incorporated by reference herein in its entirety.

### FIELD OF THE INVENTION

The invention relates to a charging connector apparatus for an electrically driven motor vehicle, said apparatus having a charging socket designed in a country-specific manner and having an adapter element for fastening the charging socket designed in a country-specific manner on a vehicle body which comprises a charging port. The invention further relates to a charging connector kit.

### BACKGROUND OF THE INVENTION

German publication DE 10 2012 105 139 A1, which is incorporated by reference herein, discloses a charging connector apparatus for a motor vehicle for charging at least one electrical energy storage device, which is electrically connected to a mating part, which is arranged by means of a charging housing part in a vehicle body such that the mating part is connectable to an externally feedable charging plug, whereby an adapter element for the releasable/permanent connection to the vehicle body is provided, to which the charging socket part can be mounted using the mating part. German publication DE 10 2012 102 419 A1, which is incorporated by reference herein, discloses a charging apparatus for a motor vehicle used to charge a vehicle-side battery, said apparatus having a charging socket assembly consisting of a charging socket designed to receive a charging plug connected to a charging cable, and an adapter device for receiving the charging socket.

### SUMMARY OF THE INVENTION

Described herein is a charging connector apparatus for an electrically driven motor vehicle, said apparatus having a charging socket designed in a country-specific manner and having an adapter element for fastening the charging socket designed in a country-specific manner on a vehicle body which comprises a charging port in that the adapter element for fastening the charging socket designed in a country-specific manner is attached to a combined drive-and-guide device for a cover which, with the aid of the combined drive-and-guide device, can be moved between a closed position in which the charging port is closed by the cover and an open position in which the charging port is exposed by the cover. With the aid of the combined drive-and-guide device, the cover can be advantageously retracted inwardly from its closed position relative to the charging port in the vehicle body. The charging port that can be closed by the cover is thereby advantageously achieved with the aid of the combined drive-and-guide device in combination with the adapter element. The adapter element can in turn be manufactured at a relatively low cost. The adapter element is preferably a plastic part. This plastic part can advantageously be manufactured in large quantities in an inexpensive manner by means of injection molding. In addition, the adapter element can be relatively easily adapted to country-specific charging sockets. Doing so enables a uniform drive-and-guide device to be easily used in different countries.

One preferred embodiment of the charging connector apparatus is characterized in that the combined drive-and-guide device is integrated into a charging tray module having a housing comprising a housing tray which, together with the adapter element, constitutes the housing of the charging tray module. Doing so provides the advantage that, among other things, no single part of the combined drive-and-guide device integrated into the charging tray module need be changed other than the adapter device.

A further preferred embodiment of the charging connector apparatus is characterized in that the housing tray and the adapter element border a receptacle space for a support frame for the cover that can be moved with the aid of the combined drive-and-guide device. The movable support frame is part of a movable component of the drive-and-guide device. The receptacle space provided in the housing enables a protected accommodation of the movable support frame without impairing the function of the combined drive-and-guide device when moving the cover between its closed position and its open position, and vice versa. In addition, the combined drive-and-guide device integrated into the charging tray module in the receptacle space is protected against environmental influences and dirt by the housing tray and the adapter element.

A further preferred embodiment of the charging connector apparatus is characterized in that the housing tray and the adapter element comprise common fastening means for fastening the housing of the charging tray module to the vehicle body. The housing tray is directly or indirectly advantageously fastened internally on the vehicle body. The fastening on the vehicle body can be performed in a bonded manner and/or using suitable fastening means, such as screws. The housing tray and the adapter element can also comprise fastening tabs and/or fastening eyes, using which the housing tray and the adapter element can be fastened together with suitable fastening means on the inside of the vehicle body.

A further preferred embodiment of the charging connector apparatus is characterized in that the adapter element comprises a fastening interface facing away from the charging port and individually adapted to the charging socket designed in a country-specific manner. A Poka-Yoke concept can advantageously be achieved thereby. The fastening interface is advantageously provided with a surface structure, which is complementary to a surface structure of the charging socket designed in a country-specific manner. The fastened charging socket to the adapted fastening interface can, e.g., be releasable using a snap-fit connection or a clip-fit connection.

A further preferred embodiment of the charging connector apparatus is characterized in that the fastening interface of the adapter element adapted to the charging socket designed in a country-specific manner comprises a receptacle having a receptacle opening for the charging socket designed in a country-specific manner. The receptacle opening of the adapter element is advantageously adapted to a mating face of the country-specific charging socket. Doing so simplifies the assembly of the charging socket designed in a country-specific manner on the adapter element.

One further preferred embodiment of the charging connector apparatus is characterized in that the receptacle opening for the charging socket designed in a country-specific manner is sufficiently large and configured such that various charging sockets can be fastened to the adapter element. The fastening interface is in this case designed such that a stable fastening of the charging socket is still possible in a simple manner. The special design of the receptacle opening preferably enables the fastening of at least two different charging sockets on the adapter element. As a result, manufacturing costs can be further reduced.

A further preferred embodiment of the charging connector apparatus is characterized in that the drive-and-guide device is attached to the housing tray. The drive-and-guide device is advantageously only attached to the housing tray. The manufacture of the adapter element is significantly simplified as a result. The adapter element is particularly advantageously only a type of rear wall in the housing of the charging tray module.

Using a charging connector kit having charging connector apparatuses as described hereinabove, the individually adapted adapter elements is associated with variously charging sockets designed in a country-specific manner. Thus, by simple means, the platform concept can be achieved in motor vehicle manufacture.

The invention optionally also relates to a motor vehicle having a charging connector apparatus as described hereinabove. The charging connector apparatus is advantageously provided somewhere in a suitable place on the vehicle body. The charging connector apparatus is advantageously integrated into a functional part of the motor vehicle. The functional part is, e.g., a bumper.

The invention further relates to an adapter element and/or a drive-and-guide device, in particular a charging tray module or a housing tray, for a charging connector apparatus as described hereinabove. The aforementioned parts can be purchased separately.

### BRIEF DESCRIPTION OF THE DRAWINGS

Further advantages, features, and details of the invention arise from the following description, in which various exemplary embodiments of the invention are described in detail with reference to the drawings.

FIG. 1 depicts a perspective view of a bumper having a charging port closed by a cover;

FIG. 2 depicts the charging port on the bumper of FIG. 1 in an opened state;

FIG. 3 depicts a transparent view of the bumper of FIGS. 1 and 2 with a drive-and-guide device fastened in the region of the charging port in the bumper;

FIG. 4 depicts a detailed perspective view of the bumper with a charging tray module and an adapter frame;

FIG. 5 depicts a perspective view of a drive-and-guide device for the cover integrated into the charging tray module;

FIG. 6 depicts a perspective view of the combined drive-and-guide device of FIG. 5, but without a housing tray and without a support frame, as well as from a different perspective;

FIG. 7 depicts a perspective view of a first adapter element designed in a country-specific manner;

FIG. 8 depicts a perspective view of a charging socket associated with the adapter element of FIG. 7;

FIG. 9 depicts a perspective view of a second adapter element designed in a country-specific manner; and

FIG. 10 depicts a charging socket associated with the adapter element of FIG. 9.

### DETAILED DESCRIPTION OF THE INVENTION

FIG. 1 shows a perspective view of a bumper 1 of a motor vehicle 2 (indicated only by a reference character). A forward direction of travel of the motor vehicle 2 is indicated in FIG. 1 by an arrow 5.

The bumper 1 is a rear bumper of the motor vehicle 2. The motor vehicle 2 is an electric vehicle that can be recharged with a charging cable (not shown) via a charging port 3. In FIG. 1, the charging port 3 is closed by a cover 4, which can also be referred to as a tailgate.

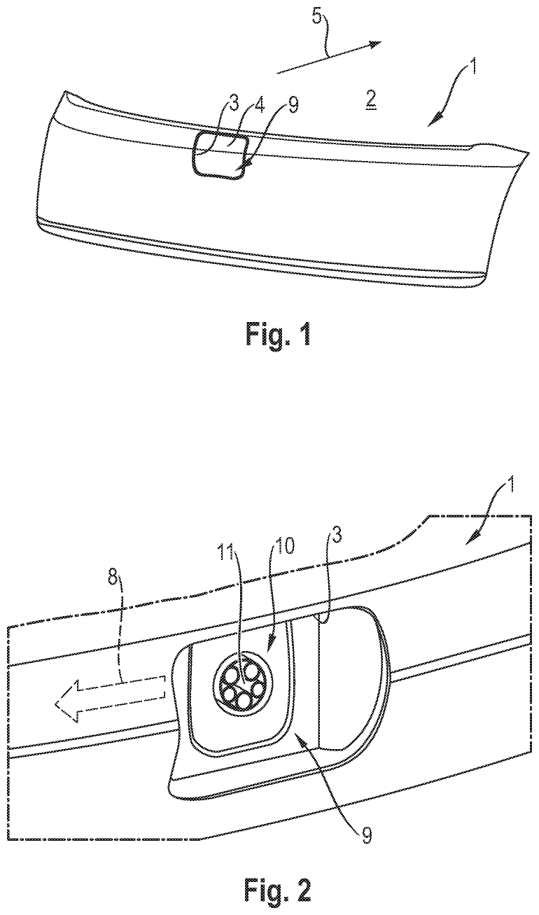

In FIG. 2, an excerpt of the bumper 1 from FIG. 1 with the charging port 3 opened (shown in an enlarged view). In FIG. 2, a port movement is indicated by an arrow 8, via which the cover bearing the reference character 4 in FIG. 1 is moved from its closed position shown in FIG. 1 into its open position. In its open position, the cover 4 is not visible, as can be seen in FIG. 2. In the open position of the cover 4, the charging port 3 is fully exposed.

In FIG. 2, it can be seen that a charging socket 10 with a mating face 11 is arranged in the bumper 1 behind the opened charging port 3. The charging socket 10 with the mating face 11 serves as a charging interface or charging connector apparatus 9 on the motor vehicle 2. This charging interface is accessible on the motor vehicle 2 through the charging port 3 in the bumper 1.

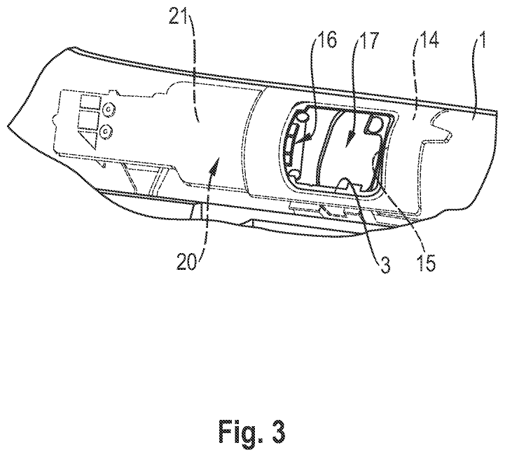

In FIG. 3, a detail of the bumper 1 with the charging port 3 is shown in a transparent view. In this illustration, it can be seen that a drive-and-guide device 16 is integrated into the bumper 1. The drive-and-guide device 16 is integrated into a charging tray module 20 having a housing tray 36.

In the bumper 1, the drive-and-guide device 16 is used in order to move the cover 4, also referred to as the tailgate, from its closed position shown in FIG. 1 into its open position, as indicated in FIG. 2, and vice versa. The cover or tailgate 4 can be automatically retracted inwardly, being electrically driven out of its closed position shown in FIG. 1 by means of the drive-and-guide device 16, as indicated in FIG. 2 by the arrow 8.

For this purpose, the drive-and-guide device 16 is equipped with an electromotive drive. Via a suitable guiding device, a rotational movement of the electromotive drive is, e.g., converted into corresponding opening movements and closing movements of the cover 4.

The drive-and-guide device 16 can be fastened directly inside the bumper 1. In the region of the charging port 3, an adapter frame 14 is fastened on the inside of the bumper 1. The adapter frame 14 comprises a port 15 through which the charging port 3 is enclosed in the bumper 1. The drive-and-guide device 16 is fastened to the adapter frame 14 in the region of the charging port 3.

The fastening of the drive-and-guide device 16 to the adapter frame 14 is, e.g., performed in a bonded manner, in particular by adhesion. Alternatively or additionally, the drive-and-guide device 16 is screwed onto the adapter frame 14. The adapter frame 14 is fastened on the inside of the bumper 1. This fastening can also be produced in a bonded manner and/or with the aid of fastening means, such as screws.

The bumper 1 having the adapter frame 14 and the drive-and-guide device 16 represents an assembly which is, e.g., assembled by a supplier. The adapter frame 14, the drive-and-guide device 16, and the bumper 1 can be manufactured at different production sites.

Assembly is then, e.g., performed by the supplier. The fully assembled unit can then be delivered to a vehicle manufacturer.

The charging socket 10, visible in FIG. 2 through the opened charging port 3 and having the mating face 11, is fastened to a support structure of the motor vehicle 2. When assembling the assembly supplied by the supplier, it is attached by the assembly port 17 via the charging socket 10 with the mating face 11. Once the assembly is correctly positioned relative to the charging socket 10 with the mating face 11, the bumper 1 can be attached to the support structure of the motor vehicle 2.

The bumper 1 and the adapter frame 14 are advantageously made of a plastic material. A housing of the drive-and-guide device 16 is also advantageously made of a suitable plastic material.

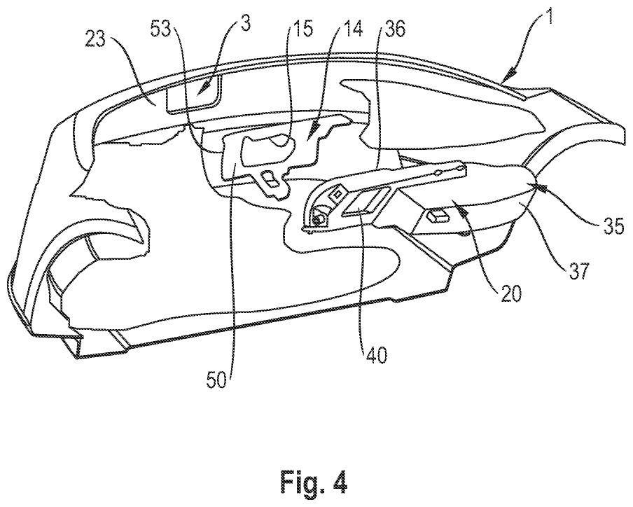

In FIG. 4, it is illustrated how the charging tray module 20 with the drive-and-guide device integrated therein for the cover is mounted on the inside of the bumper 1. The charging tray module 20 can be mounted directly inside the bumper 1, e.g., in a bonded manner and/or with the aid of suitable fastening means. It is shown in FIG. 4 that an adapter frame 14 can also be used on the inside of the bumper 1 in order to fasten the charging tray module 20.

The adapter frame 14 is advantageously equipped on one side with a unit fastening point 50, at which the charging tray module 20 can be quickly and easily positioned and fastened. On a side facing away from the unit fastening point 50, the adapter frame 14 has a fastening interface 53 that is adapted to the bumper 1.

The adapter frame 14 provides the advantage that the same charging tray module 20 can be used for different bumpers or bumper variants. The fastening interface 53 of the adapter frame 14 thereby need only be adapted to the respective bumper or the respective bumper variant. Nothing need be changed on the charging tray module 20.

The adapter frame 14 comprises a port 15, which also serves as the charging port 3. The charging tray module 20 comprises a through-hole 40, which also serves as the charging port 3. A charging socket bearing reference character 10 in FIG. 2 is, e.g., attached to the charging tray module 20, which can be exposed or covered with the aid of the cover.

The charging tray module 20 comprises a housing 35 having a housing tray 36 and a housing rear wall 37. The through-hole 40 extends through the housing 35 with the housing tray 36 and the housing rear wall 37. The charging tray module 20 is mounted with its housing tray 36, directly or indirectly with the interposition of the adapter frame 14, on the inside of an outer skin 23 of the bumper 1.

In contrast to what is shown, the charging tray module 20 can also be mounted at another location of the outer skin 23 of a motor vehicle or a motor vehicle body. The charging tray module 20 can also in this case be mounted to a body of the motor vehicle, either directly or indirectly with the interposition of the adapter frame 14.

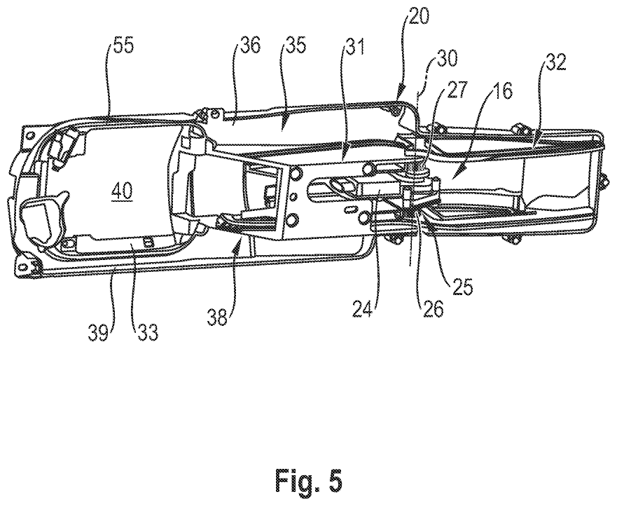

In FIG. 5, the charging tray module 20 is shown in a perspective view, without the housing rear wall 37, in order to visualize the arrangement of the combined drive-and-guide device 16 in the housing 35 of the charging tray module 20. The drive-and-guide device 16 is fixed with its housing-fixed components to the housing tray 36, which is also referred to as the charging tray. The name “charging tray module” comes from the term “charging tray.”

The drive-and-guide device 16 integrated into the charging tray module 20 comprises a gearwheel/rack combination 25 having two gearwheels 26, 27 and two racks 28, 29. The two gearwheels 26, 27 are electromotively driven about a common axis of rotation 30, e.g. by an electromotor 24, which is integrated into the charging tray module 20. The electromotor 24 is fastened internally on the housing tray 36.

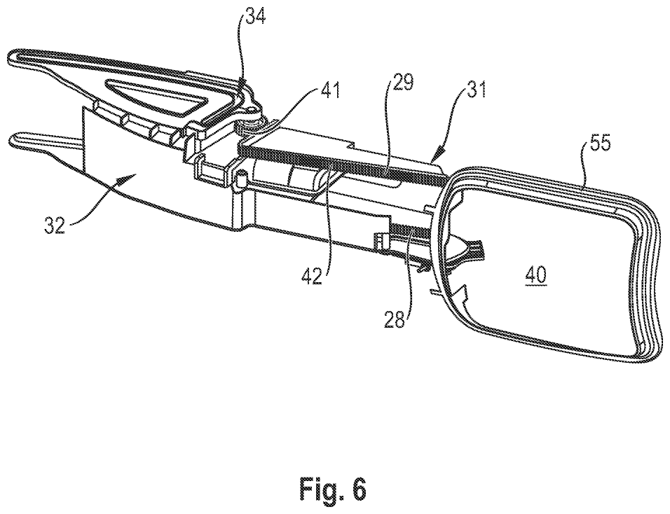

In FIG. 6, two racks 28, 29 of the gearwheel/rack combination 25 are visible. The two racks 8 and 29 each comprise a lifting portion 41 and a pushing portion 42. The lifting portion 41 is arranged substantially perpendicular to the pushing portion 42. The lifting portion 41 is used for a lifting movement of the cover 4. The pushing portion 42 serves for a pushing movement or translational movement of the cover 4.

The gearwheel 26 meshes with the rack 28. The gearwheel 27 meshes with the rack 29. A rotational movement of the gearwheels 26, 27 moves a movable guiding component 31 of the drive-and-guide device 16 relative to a housing-fixed guiding component 32.

The movable guiding component 31 comprises a support frame 33 to which the racks 28 and 29 are attached. The housing-fixed guiding component 32 comprises the electromotor 24. Relative movements of the movable guiding component 31 relative to the housing-fixed guiding component 32 are guided through a double slotted guide 34.

The housing 35 of the charging tray module 20 comprises a receptacle space 38 for the movable guiding component 31 with the support frame 33 and the cover 4. The receptacle space 38 is in this case designed and dimensioned such that the movable guiding component 31 can perform the movements without interference when the cover 4 moves between its open position and its closed position.

A frame 55 for the cover 4 is attached to one end of the support frame 33. This frame 55 is arranged in a fastening frame 39 formed on the housing tray 36.

The support frame 33, the fastening frame 39, and the frame 55 for the cover 4 comprise a through-hole 40, which is used as the charging port (bearing reference character 3 in FIG. 1) in the outer skin 23 and in the bumper 1. When the cover 4 is in its closed position, the through-hole 40 is closed. In its open position, the cover 4 exposes the through-hole 40.

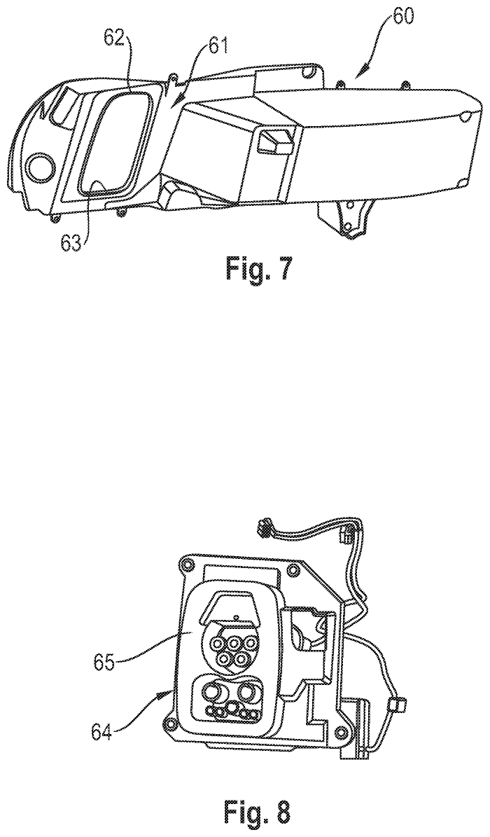

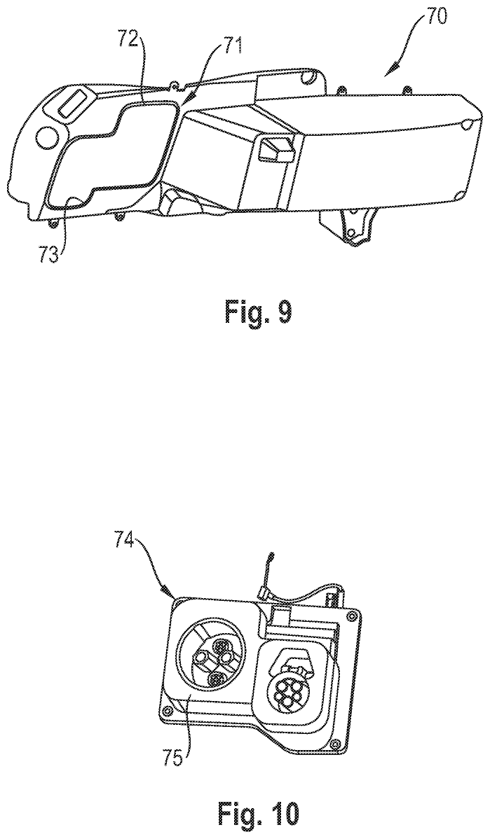

In FIGS. 7 and 9, two adapter elements 60; 70 are shown in a perspective view. The adapter elements 60; 70 replace the housing rear wall of the housing 35 of the charging tray module 20 (bearing reference character 37 in FIG. 4). Both adapter elements 60; 70 can be assembled into a housing 35 with the housing tray 36 and the combined drive-and-guide device 16 built thereon, as shown in FIG. 5.

The adapter elements 60; 70 are advantageously equipped with a country-specific fastening interface 61; 71 for combination with a dedicated country-specific charging socket 64; 74, which is shown in FIGS. 8 and 10.

The country-specific fastening interface 61; 71 comprises a receptacle 62; 72 having a receptacle opening 63; 73 which is designed to be complementary to a mating face 65; 75 of the country-specific charging socket 64; 74.

The country-specific charging socket 64; 74 can be first mounted on the fastening interface 61; 71 of the adapter element 60; 70, depending on a desired mounting sequence. However, it is also possible to first assemble the adapter element 60; 70 having the housing tray 36, as shown in FIG. 5, before the respective charging socket 64; 74 is then mounted on the fastening interface 61; 71.

### REFERENCE CHARACTERS

1 Bumper
2 Motor vehicle
3 Charging port
4 Cover
5 Forward direction of travel
8 Opening movement
9 Charging interface or charging connector apparatus
10 Charging socket
11 Mating face
14 Adapter frame
15 Port
16 Drive-and-guide device
17 Assembly port
20 Charging tray module
23 Outer skin
24 Electric motor
25 Gearwheel/rack combination
26 Gearwheel
27 Gearwheel
28 Rack
29 Rack
30 Axis of rotation
31 Movable guidance component
32 Housing-fixed guidance component
33 Support frame
34 Double slotted guide
35 Housing
36 Housing tray
37 Housing rear wall
38 Receptacle space
39 Fastening frame
40 Through-hole
41 Lifting portion
42 Pushing portion
50 Unit fastening point
53 Fastening interface
55 Frame
60 Adapter element
61 Fastening interface
62 Receptacle
63 Receptacle port
64 Charging socket
65 Mating face
70 Adapter element
71 Fastening interface
72 Receptacle
73 Receptacle port
74 Charging socket
75 Mating face

What is claimed is:

1. A charging connector apparatus for an electrically driven motor vehicle, said apparatus comprising:
a charging socket configured in a country-specific manner; and
an adapter element for fastening the charging socket on a vehicle body, the adapter element comprising a charging port;
wherein the adapter element is attached to a combined drive-and-guide device for a cover which, with the aid of the combined drive-and-guide device, is configured to be moved between a closed position, in which the charging port is closed by the cover, and an open position, in which, with the aid of the combined drive-and-guide device, the charging port is exposed by the cover.

2. The charging connector apparatus according to claim 1, wherein the combined drive-and-guide device is integrated into a charging tray module having a housing comprising a housing tray which, together with the adapter element, constitutes the housing of the charging tray module.

3. The charging connector apparatus according to claim 2, wherein the housing tray and the adapter element border a receptacle space for a support frame for the cover, which support frame is movable with the aid of the combined drive-and-guide device.

4. The charging connector apparatus according to claim 3, wherein the housing tray and the adapter element comprise fastening means for fastening the housing of the charging tray module to the vehicle body.

5. The charging connector apparatus according to claim 1, wherein the adapter element comprises a fastening interface facing away from the charging port and individually adapted to the charging socket that is configured in a country-specific manner.

6. The charging connector apparatus according to claim 5, wherein the fastening interface of the adapter element comprises a receptacle having a receptacle opening for the charging socket.

7. The charging connector apparatus according to claim 6, wherein the receptacle opening for the charging socket is sized such that a variety of different charging sockets can be fastened to the adapter element.

8. The charging connector apparatus according to claim 1, wherein the drive-and-guide device is attached to the housing tray.

9. A charging connector kit comprising a plurality of the charging connector apparatuses according to claim 1, wherein individually designed elements are associated with variously configured charging sockets designed in a country-specific manner.

10. An electrically driven motor vehicle comprising the charging connector apparatus of claim 1.
